(19) United States
(12) Patent Application Publication
(10) Pub. No.: US 2026/0222024 A1
(43) Pub. Date: Jul. 30, 2026

(54) MULTIPLE USER MULTIPLE INPUT MULTIPLE OUTPUT (MU-MIMO) TRANSMISSION PRECODER MANAGEMENT USING USER EQUIPMENT (UE) GROUPING BASED ON LOCATION

(71) Applicant: Kyocera Corporation, Kyoto (JP)

(72) Inventors: Amit KALHAN, San Diego, CA (US); Henry CHANG, San Diego, CA (US)

(21) Appl. No.: 19/146,755

(22) PCT Filed: Feb. 7, 2024
(86) PCT No.: PCT/US2024/014813

§ 371 Date: Jul. 9, 2025

Related U.S. Application Data
(60) Provisional application No. 63/445,182, filed on Feb. 13, 2023.

(51) Int. Cl. H04B 7/0456

(52) U.S. Cl. CPC H04B 7/0456

(57) ABSTRACT

The base station selects and instructs a reporting UE device to provide wide-beam precoder information indicative of a wide-beam precoder (W1). The base station tracks the locations of the reporting UE device and other UE devices and identifies at least one cluster UE device that is within a maximum distance from the reporting UE device. Without receiving wide-beam procedure information from the at least one cluster UE device, the base station applies a MU-MIMO precoder to transmissions through multiple antennas to the cluster UE device where the MU-MIMO precoder uses a wide-beam precoder (W1) based, at least partially, on the wide-beam precoder information received from the reporting UE device.

### CLAIM OF PRIORITY

The present application claims priority to Provisional Application No. 63/445,182, entitled “UE's Location based Grouping for the Multiuser MIMO Transmissions,” docket number TPRO 00383 US, filed Feb. 13, 2023, assigned to the assignee hereof and hereby expressly incorporated by reference in its entirety.

### FIELD

This invention generally relates to wireless communications and more particularly to Multiple User Multiple Input Multiple Output (MU-MIMO) transmission precoder management using user equipment (UE) grouping based on location.

### BACKGROUND

Many wireless communication systems that employ several base stations that provide wireless service to user equipment (UE) devices enable sidelink communication between two or more UE devices where the UE devices can communicate directly with other UE devices. In addition, one or more UE devices can be used as relay devices between a source UE device and a destination UE device where the relay devices forward data received from the source UE device to the destination UE device. In many conventional communication systems, a serving base station (serving gNB) applies a precoder matrix to transmissions to the UE devices through multiple antennas at the base station. Some systems utilize Multiple User Multiple Input Multiple Output (MU-MIMO) techniques for transmission of signals from multiple antennas at a base station to multiple UE device where a MU-MIMO precoder matrix is applied to the transmissions to enhance the achievable data rates of the transmission to each UE device. With MU-MIMO, a multi-antenna transmitter communicates simultaneously with multiple receivers. Each receiver may have one or multiple antennas. The MU-MIMO precoder facilitates beam forming or other communication channel adjustments where transmission antenna beams are formed to maximize the signal strength of each stream directed to each target UE device.

### SUMMARY

The base station selects and instructs a reporting UE device to provide wide-beam precoder information indicative of a wide-beam precoder (W1). The base station tracks the locations of the reporting UE device and other UE devices and identifies at least one cluster UE device that is within a maximum distance from the reporting UE device. Without receiving wide-beam precoder information from the at least one cluster UE device, the base station applies a MU-MIMO precoder to transmissions through multiple antennas to the cluster UE device where the MU-MIMO precoder uses a wide-beam precoder (W1) based, at least partially, on the wide-beam precoder information received from the reporting UE device.

### BRIEF DESCRIPTION OF THE DRAWINGS

FIG. 1A is a block diagram of a communication system where a reporting UE device transmits wide-beam precoder information to a serving base station.

FIG. 1B is a block diagram of the system for an example where the base station applies a different wide-beam precoder to each UE device cluster of multiple UE clusters.

FIG. 1C is a block diagram of an example of an antenna beam configuration for a MU-MIMO precoder that is equal to the product of a wide-beam precoder (W1), an intermediate-wide precoder (W3), and a UE-specific precoder (W2).

FIG. 2 is a block diagram of an example of a base station suitable for use as the base station of FIG. 1.

FIG. 3 is a block diagram of an example of a UE device suitable for use as each of the UE devices.

FIG. 4 is a message flow diagram for an example where a MU-MIMO precoder is applied to transmissions to three UE devices in a UE cluster and the MU-MIMO precoder is the product of a wide-beam precoder for the UE cluster provided by a reporting UE device of the UE cluster and another precoder based on UE-specific precoder information measured by each UE device.

FIG. 5A is a block diagram of the system for an example where the base station selects reporting UE devices from geographical regions to report wide-beam precoder information.

FIG. 5B is a block diagram of the system for an example where each reporting UE device reports wide-beam precoder information and the base station broadcasts regional wide-beam precoder information.

FIG. 5C is a block diagram of the system for an example where UE devices report UE-specific precoder information when the UE device determines that a preferred wide-beam precoder measured by the UE device matches one of the wide-beam precoders identified by the regional wide-beam precoder information.

FIG. 6A is a block diagram of the system for an example where the base station 106 receives generates a region to wide-beam precoder mapping based on wide-beam precoder information received from a plurality of reporting UE devices.

FIG. 6B is a block diagram of the system for an example where the base station transmits a region to wide-beam precoder mapping message.

FIG. 6C is a block diagram of the system for an example where the UE device 660 transmits a wide-beam precoder index and UE-specific precoder information in an initial transmission and transmits UE specific precoder information without wide-beam precoder information in subsequent reports.

### DETAILED DESCRIPTION

As discussed above, a serving base station (serving gNB) using MU-MIMO may apply a MU-MIMO precoder (such as a MU-MIMO precoder matrix) to transmissions to the UE devices through multiple antennas at the base station. The channel from the multiple antennas of the base station to an antenna of a UE device is a correlated random vector with covariance matrix that depends on the scattering geometry. Where the base station is a macro-cellular tower-mounted base station with no significant local scattering, the propagation between the base station antennas and any given UE device antenna is characterized by the local scattering around the UE device, resulting in the one-ring model. The signal vector received by the UE devices is given by

$$y = {H}^{H} Wd + z = {H}^{H} x + z$$

where M is the number of base station antennas, K is the number of UE devices, H denotes the M×K system channel matrix given by stacking the K users channel vectors by columns, W is the M×S precoding matrix with S is the rank of the input covariance Σ= [symbol] [Wdd^{H}W^{H}] (i,e., the number of independent data streams sent to the users), d is the S-dimensional transmitted data symbol vector, and z~ [symbol] (0, I) denotes the Gaussian noise at the UE device receiver. The transmit signal vector is given by x=Wd. After appropriate partitioning of the UE devices such that users in the same group are nearly co-located and different groups are sufficiently well separated in the angle of arrival (AoA) domain, the structure of the channel covariance matrices can be leveraged to reduce the dimensionality of the effective channels. As a result, large multiplexing gains are achieved with reduced dimension channel training and Channel State Information (CSI) feedback. The precoding matrix can be split to be a product of two precoders (W=W₁W₂). The two precoders may include a wideband precoder, W₁, and a UE-specific precoder, W₂. With such a precoder product structure, W₂ selects vectors from the wideband W₁ and adjusts the phase between the selected beams. As a result, the wideband and long-term CSI properties are addressed by W₁ while the short-term and frequency-selective CSI properties are addressed by W₂. The required update rate in time and frequency differs between W₁ and W₂. For W₁, the update frequency can be relatively low while the update rate for W₂ is higher.

The resulting precoder in MU-MIMO, therefore, is a combination of the individual precoders. In one example, each precoder is represented by a matrix and the combination of precoders is the product of the matrices. In practice, precoders are implemented by applying a complex-gain (amplitude and phase) weight to each antenna element which can be done in the digital or analog domain or partially in the digital domain and partially in the analog domain (hybrid MIMO processing). The precoding algorithms that compute the antenna weights for each antenna element can be sub-divided into linear and nonlinear precoding types. Nonlinear algorithms result in the maximum data rate achievable for given channel conditions. Although the capacity achieving algorithms are nonlinear, linear precoding technologies typically provide reasonable performance with less complexity. Examples of linear precoding strategies include maximum ratio transmission (MRT), zero-forcing (ZF) precoding, and transmit Wiener precoding. Nonlinear precoding is based on the concept of dirty paper coding (DPC), where any known interference at the transmitter can be subtracted without the penalty of radio resources if the optimal precoding scheme can be applied on the transmit signal.

For some examples herein, a base station uses wide-beam precoder information, provided by a reporting UE device, to determine a wide-beam precoder for transmission to other UE devices that are relatively close to the reporting UE device. The base station determines the geo-location of the reporting UE device and other UE devices based on information provided by the UE devices and/or cellular based positioning techniques such as 5G NR multi-cell Round Trip Time (multi-RTT) positioning procedures. Based on the geo-locations (positions) of the UE devices, the base station identifies cluster UE devices that are within a maximum distance from the reporting UE device. The base station uses the wide-beam precoder information to set the wide-beam precoder portion (W₁) of the MU-MIMO precoder (W) for transmissions to the reporting UE device and for transmissions to the cluster UE devices without receiving wide-beam precoder information from the cluster UE devices. By appropriately setting the maximum distance, the reporting UE device and the cluster UE devices are considered to be co-located for purposes of the wide-beam precoder, W₁. Signaling overhead is reduced since the channel feedback information related to the wide-beam precoder, W₁, is not transmitted by the cluster UE devices. For the examples, however, all UE devices report the UE-specific precoder information related to the UE-specific precoder matrix, W₂, where the MU-MIMO precoder is based on the combination of the wide-beam precoder and the UE-specific precoder. As discussed herein, a UE-specific precoder is not necessarily unique to a particular UE device although where UE devices are separated by a sufficient distance, the UE-specific precoders (and MU-MIMO precoders) applied to transmissions to different UE devices are different.

In some situations, the base station may request only the UE-specific precoder information from the cluster UE devices in order to limit the amount of information provided by the cluster UE devices. In other situations, the base station sends grouping information to the UE devices indicating the group, if any, to which each UE device has been assigned. A UE device does not send wide-beam precoder information if it is notified that it is a cluster UE device belonging to a group. In response to a request for precoder information, for example, a cluster UE device only reports UE-specific precoder information to the base station. The cluster UE device may also report unsolicited UE-specific precoder information. The cluster UE device, for example, may periodically report UE-specific precoder information or may report UE-specific precoder information in response to a trigger.

The cluster UE device may also determine whether the group to which it has been assigned is associated with a preferred wide-beam precoder. The cluster UE device, therefore, may measure channel characteristics to determine the preferred or best wide-beam precoder that should be used to transmits signals from the base station to the cluster UE device. The UE cluster compares the preferred wide-beam precoder to the wide-beam precoder associated with the group to which the cluster UE device has been assigned and notifies the base station if the preferred wide-beam precoder is not the wide-beam precoder that has been assigned to the cluster UE device. The notification may be provided to the base station using any of several techniques where some examples include providing a notification in a message (or control signal) and reporting the wide-beam precoder information that identifies the preferred wide-beam precoder. Based on the reported information, the base station takes action to address the mismatch such as assigning the cluster UE device to the more appropriate group. In one example, the cluster UE device executes a precoder information reporting scheme in accordance with conventional techniques in response to determining that the assigned wide-beam precoder is not preferred wide-beam precoder. With such a scheme, therefore, the UE device reports the preferred wide-beam precoder information.

In other examples herein, the base station selects a plurality of reporting UE devices based on their location and receives, from the plurality of reporting UE devices, reported wide-beam precoder information where at least one reporting UE device is located in each of a plurality of geographical regions. The base station determines a plurality of wide-beam precoders based, at least partially, on the reported wide-beam precoder information and assigns each wide-beam precoder to each of the plurality of geographical regions. The base station broadcast regional wide-beam precoder information identifying the plurality of wide-beam precoders where the number of wide-beam precoders identified in the regional wide-beam precoder information less than a total number of wide-beam precoders used for transmissions from the base station. Another UE device receives the wide-beam precoder information and determines if a preferred wide-beam precoder measured by the UE device matches any of the wide-beam precoders identified in the regional wide-beam precoder information. If the UE device determines that measured preferred wide-beam precoder matches one of the wide-beam precoders identified in the regional wide-beam precoder information, the UE device transmits UE-specific precoder information indicative of a UE-specific precoder. The base station applies a MU-MIMO precoder for transmissions through a plurality of antennas to the UE device where the MU-MIMO precoder is equal to a combination of the wide-beam precoder assigned to a geographical region and the UE-specific precoder. In some situations where the UE-specific precoder is unique to the wide-beam precoder, the base station determines the wide-beam precoder assigned to the geographical region where the UE device is located based on the UE-specific precoder information. In other situations, the UE device transmits a wide-beam precoder index value identifying the wide-beam precoder that matches the measured preferred wide-beam precoder. When the measured preferred wide-beam precoder does not match any of the wide-beam precoders in the regional wide-beam precoder information, the UE device transmits UE-specific precoder information and wide-beam precoder information identifying the preferred wide-beam precoder.

In yet another example, the base station transmits regional wide-beam precoder information that includes a geographical region to wide-beam precoder mapping. For the example, the base station 106 performs a wide-beam precoder data acquisition and mapping procedure where reporting UE devices provide regional wide-beam precoder information during the data acquisition period and the base station compiles and evaluates, or otherwise processes, the data to define region boundaries and to generate a mapping between the regions and wide-beam precoders. A UE device may use the region to precoder mapping to limit the wide-beam precoder information that it provides to the base station. In some situations, the UE device in RRC_CONNECTED determines its current region, verifies that the UE device's measured preferred wide-beam precoder matches the assigned wide-beam precoder for the current region, and reports the wide-beam precoder information only in an initial report. Although the UE device initially reports the wide-beam precoder information with UE specific precoder information, the UE device only reports UE-specific precoder information in subsequent reports unless the UE device moves to a new region. The UE device may detect that it has moved to new region based on its location and/or based on measuring a new preferred wide-beam precoder.

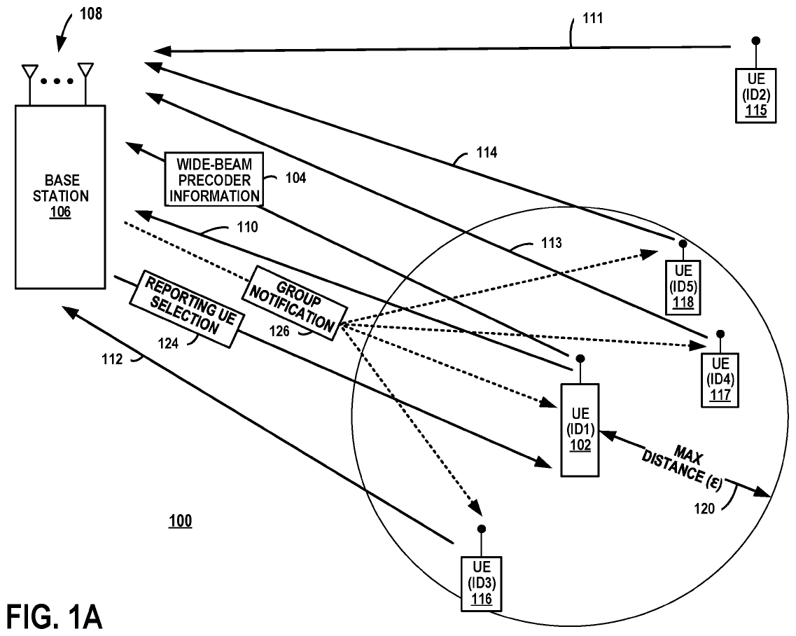

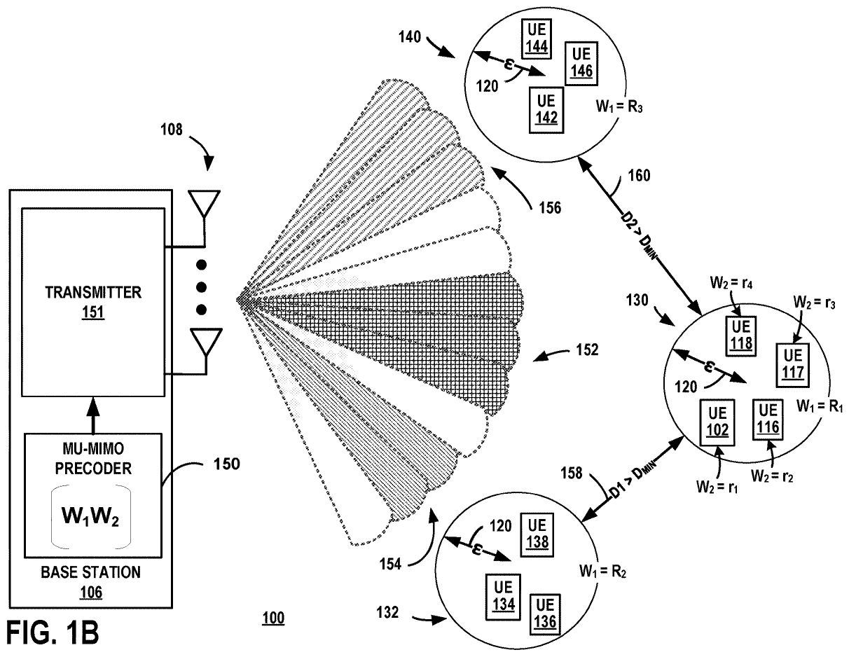

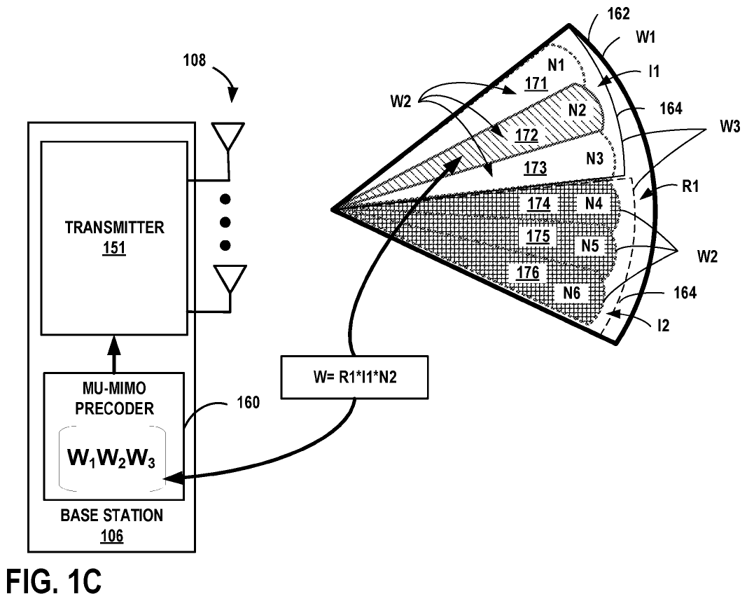

FIG. 1A is a block diagram of a communication system 100 where a reporting UE device 102 transmits wide-beam precoder information 104 to a serving base station 106. As discussed below in further detail, the base station 106 includes multiple antennas 108 and applies a MU-MIMO precoder to transmissions through the multiple antennas 108 to UE devices. The base station 106 determines the geographical location (geo-location) of several UE devices including the reporting UE device 102. For the examples herein, the base station determines the locations based, at least partially, on signals 110-114 transmitted by the UE devices and received by the base station 106. In some situations, of or more of the received signals 110-114 may include Global Positioning Satellite (GPS) coordinates, Global Navigation Satellite System (GNSS) coordinates, and/or indoor location indicators. In other situations, 5G NR multi-cell Round Trip Time (multi-RTT) techniques are used to determine one or more locations. With multi-RTT, the base station transmits downlink (DL) positioning reference signals (RS) (DL-PRS) and the UE devices transmit uplink (UL) sounding RS (UL-SRS). The UL-SRS are received and measured at the base station and the DL-PRS are received and measured at each UE device. For the DL-based positioning, a UE device reports the ToA (Time of Arrival) difference for PRSs received from multiple distinct base stations, and the location server uses the reports to determine the position of the UE device. For the UL-based positioning, the base stations (with assistance from the location server) measure the arrival time, the angle-of-arrival (AoA) and the received power of the received SRSs to estimate the location of the UE device. In still other situations, the base station may use angle of arrival (AoA) and signal strength measurements to determine the geo-location of UE device. Other techniques can be also be used for determining the locations of the UE devices where some examples include using machine vision, radar, and lidar. In some situations, the base station may determine locations at least partially based on information provided by other UE devices. In some situations, for example, one or more UE devices may provide neighbor lists to the base station where the neighbor lists either indirectly ort explicitly provide the locations of other UE devices. Therefore, the received signals 110-114 from the UE devices 102, 115-118 may include location information, may be reference signals, or may be any other type of signal that at least assists the base station in determining the location of the UE devices 102, 115-118.

Based at least partially on characteristics of the signals and/or information transported by the signals, the base station 106 identifies a subset of UE devices 116-118 of a plurality of UE devices 115-118 that are within a maximum distance, ε, 120 from the reporting UE device 102. This subset is part of group associated with the reporting UE device 102 where a group is sometimes referred to as a UE device cluster, herein. For the example of FIG. 1A, the maximum distance, ε, 120 is set by the network. The value of the maximum distance, ε, 120 is based on the particular system implementation which may include several factors, such as the deployment scenario, mobility, channel environment and the frequency band. In some situations, the maximum distance values are determined by conducting field-trials and/or simulations. For the example, the base station and/or network sets one maximum distance per hierarchical level defined based on the beam width of the hierarchical level that the base station will use as the upper precoder. Depending upon the channel conditions and the environment, the base station and/or network determines the maximum distance for the group that is appropriate. Also, the base station 106 and/or network may determine the maximum distance and the preferred hierarchical level based on the number of transmission antennas available.

The base station and/or network selects at least one UE device to be a reporting UE device 102 and notifies that UE device 102 of the selection. The base station 106, therefore, selects the UE devices that are to report wide-beam precoder information and sends a reporting UE selection message 124 to each selected UE device. The message 124 may include information such as a schedule of reporting, such as the frequency of report transmissions to the base station, and/or events that should trigger a report. The base station and/or the network may set the periodicity of the reports based on factors such as the system deployment scenario, mobility, blockage probability, and the operating frequency band. For the example of FIG. 1A, the base station 106 sends an RRC Reconfiguration message to the selected reporting UE device instructing the UE device to measure the downlink reference signal (DL RS). In some cases, the base station 106 may configure multiple UE devices within a group to check the consistency of the reported wide-beam precoder information 104. When the base station 106 determines that a reporting UE device should be changed to another UE device within the same group, the base station 106 sends an RRC Reconfiguration message to de-configure the current reporting UE device and sends another RRC Reconfiguration to another UE device to initiate reporting from the new UE device.

After receiving at least one wide-beam precoder information message 104 (e.g., measurement report), the base station 106 and/or network groups all the other neighboring UE devices in the RRC CONNECTED state that are located within the maximum distance, ε, 120 of the reporting UE device 102 to form a UE device cluster (group). Accordingly, where a UE device is within the maximum distance of a reporting UE device, the UE device is assigned a group that includes the reporting UE device and the other UE devices within the maximum distance of the reporting UE device.

In another example, with reference to FIG. 1A, not all neighbor UE devices 116-118 need to be RRC CONNECTED. One or more of the neighbor UE devices 116-118 may be in RRC IDLE or RRC INACTIVE. Typically, when an RRC IDLE UE attempts to CONNECT to Base Station 106, a neighbor UE device 116 would first select a wideband beam i.e., SSB and perform a PRACH process corresponding to the preferred SSB #. However, since the neighbor UE device 116 is already associated with a group, it may use the same SSB #broadcasted in SIB for its group. Since Base Station 106 already knows the neighbor UE device's SSB based on grouping, there is no need for the neighbor UE device 116 to send the redundant information to Base Station 106. Hence, Base Station 106 can go directly to configuring CSI-reportConfig to neighbor UE device 116 to obtain the neighbor UE device's UE-specific information.

The reporting UE device 102 determines wide-beam precoder information to be used to determine the wide-beam precoder, W₁, that should be applied by a MU-MIMO precoder at the base station 106 for transmissions through multiple antennas to the reporting UE device 102. In some situations, the reporting UE device 102 measures the channel measured channel covariance matrix, R₁, that determines the wide-beam precoder (W₁) that will be applied by the base station. In other situations, the reporting UE device 102 may identify a wide-beam antenna beam as the best antenna beam. With some techniques, for example, the base station transmits a Synchronization Signal Block (SSB) over several wide-beam antenna beams and the reporting UE device identifies the best wide-beam antenna beam. The wide-beam precoder information may include an SSB indicator that identifies the best SSB antenna beam. The transmitted wide-beam precoder information may also be the measured channel covariance matrix, R₁, or may be an index identifying the wide-beam precoder (W₁) from a set of precomputed matrices. The wide-beam precoder information 104, therefore, may be any information, parameter, or indicator that allows the base station to determine the wide-beam precoder, W₁, for use by the MU-MIMO precoder at the base station 106. For the example, the techniques and procedures for determining the wide-beam precoder information 104 are in accordance with known techniques. The reporting UE device transmits the wide-beam precoder information 104 to the base station 106.

In many situations, the precoders are based on matrices. In other situations, however, a precoder may be established using other techniques. For example, machine learning (ML) techniques may be utilized to adjust parameters that establish the precoder.

The base station 106 notifies each UE device assigned to a group that the UE device has been assigned to the group. For the example of FIG. 1A, the base station 106 broadcasts a group notification message 126 that is received by the reporting UE device 102 and by the UE devices 116-118 assigned to the same group. The broadcasted group notification message 126 may identify multiple groups and, therefore, may be received by UE devices assigned to other groups. For the examples herein, the group notification message 126 identifies the wide-beam precoder that is associated with the group. Accordingly, each UE device assigned to a group is notified that it has been assigned to the group and is notified of the wide-beam precoder that will be used for transmission from the base 106 station to the UE device.

The group notification message 126 may be broadcasted using any of serval techniques. In one example, the group notification is broadcasted in a System Information Block (SIB) that includes a list of cluster UE devices in RRC_CONNECTED that belong to each group. In some situations, the SIB also includes some indication of the wide-beam precoder that will be used for each group. The SIB, for example, may include the SSB index that is associated with each group. The SIB is transmitted at least when changes to the group mapping occur. For example, due to mobility of the UE devices, a cluster UE device belonging to one group may be assigned a new group when the cluster UE device moves from a first region near a first reporting UE device to a second region near a second reporting UE device. The frequency of SIB transmission is typically based on how often at least one of the cluster UE devices is reassigned to a different group (cluster).

In another example, the group notification is provided by the base station via a MIMO Control Channel (MiCCH) that is broadcast periodically. For the example, a SIB provides the radio resource of the MiCCH. A Logical Channel ID (LCID) is assigned to the MiCCH which is mapped to the downlink traffic channel (e.g., Downlink Shared Channel (DL-SCH)). A header of the MiCCH includes group identifiers where MIMO-Radio Network Temporary Identifiers (Mi-RNTIs) can be used as the UE IDs. Each UE device decodes the message associated with the UE devices assigned group identified by the Mi-RNTI assigned by the base station. For the example, the message in the MiCCH for a particular Mi-RNTI includes a listing of all UE devices assigned to the group (cluster). The UE devices can be listed in the MiCCH by their C-RNTI. In some situations, the MiCCH only contains the UE devices that have been either moved or added since the last MiCCH transmission. In some situations, the MiCCH includes a change indicator that indicates whether any of the group assignments have changed. A UE device can skip decoding the remainder of the MiCCH if there are no changes. The change indicator may be advantageous in situations where the cluster UE devices are stationary, such as where UE device that are implemented in a factory to perform sensing.

FIG. 1B is a block diagram of the system 100 for an example where the base station 106 applies a different wide-beam precoder to each UE device cluster of multiple UE clusters. For the example, a first UE cluster 130 includes a first reporting UE device 102 and three non-reporting UE devices 116-118, a second UE cluster 132 includes a second reporting UE device 134 and two non-reporting UE devices 136, 138, and a third UE cluster 140 includes a third reporting UE device 142 and two non-reporting UE devices 144, 146. Each reporting UE device 102, 134, 142 measures the wide-beam precoder and sends wide-beam precoder information indicative of the measured wide-beam precoder. Accordingly, the first reporting UE device 102 transmits first wide-beam precoder information to the base station 106. The first reporting UE device 102 measures the first wideband matrix, R₁ and transmits the first wide-beam precoder information indicative of the measured R₁ to the base station 106. The second reporting UE device 134 transmits second wide-beam precoder information to the base station 106. The second reporting UE device 134 measures the second wideband matrix, R₂ and transmits the second wide-beam precoder information indicative of the measured R₂ to the base station 106. The third reporting UE device 142 transmits third wide-beam precoder information to the base station 106. The third reporting UE device 142 measures the third wideband matrix, R₃ and transmits the third wide-beam precoder information indicative of the measured R₃ to the base station 106.

The base station 106 applies a precoder matrix 150 to transmissions for each UE device of a UE cluster that includes the wide-beam precoder identified by the reporting UE device for the particular UE cluster. A transmitter 151 in the base station 106 is connected to the plurality of antennas 108 which may include a single antenna with multiple antenna elements or may include multiple separate antennas. The plurality of antennas 108 may include any number of antennas more than one. The MU-MIMO precoder, W, is the combination of the wide-beam precoder, W₁, and a UE-specific precoder, W₂. The wide-beam precoder, W₁, is set to be the same for all UE devices in a particular UE cluster. Accordingly, the wide-beam precoder, W₁, for transmissions to UE devices 102, 116-118 in the first UE cluster 130 is R₁, the wide-beam precoder, W₁, for transmissions to UE devices 134, 136, 138 in the second UE cluster 132 is R₂, and the wide-beam precoder, W₁, for transmissions to UE devices 142, 144, 146 in the third UE cluster 140 is R₃. The MU-MIMO precoder matrix, W, 150 is also based on the UE-specific precoder, W₂, for the particular UE device. In one example, the base station 106 requests that each UE device that will receive a transmission to measure and provide UE-specific precoder information that the base station will use to determine the UE-specific precoder. For example, the base station 106 may request that each UE device in the first cluster 130 measure and provide UE-specific precoder information. In another example, the UE device reports the UE-specific precoder information in response to receiving the group identifier. In still another example, the UE device provides only the UE-specific precoder information in response to a request for precoder information when the UE device has been notified that it is a member of a group.

The base station 106 determines the UE-specific precoder based on the UE-specific precoder information for each device and applies the MU-MIMO precoder data transmission to each UE device where the MU-MIMO precoder uses the UE-specific precoder based on the UE-specific precoder information provided by each UE device and the wide-beam precoder for the cluster. For the example of FIG. 1B, the reporting UE device 102, the UE device 116, the UE device 117, and the UE device 118 each measure channel characteristics based on a precoder measurement configuration provided by the base station to determine the UE-specific precoder information used by the base station to determine the UE-specific precoder, W₂, equal to r₁, r₂, r₃, and r₄, respectively. For the transmissions to the reporting UE device 102, through the multiple antennas 108, the base station 106 applies a precoder matrix based on the first cluster wide-beam precoder and the UE-specific precoder based on the measurements of the reporting UE device 102 (W=W₁W₂=R₁r₁). The precoder matrix for transmissions to the UE device 116 is based on the first cluster wide-beam precoder and the measurements of the UE device 116 to determine the UE-specific precoder (W=W₁W₂=R₁r₂). The precoder matrix for transmissions to the UE device 117 is based on the first cluster wide-beam precoder and the UE-specific precoder information measured by the UE device 117 (W=W₁W₂=R₁r₃). The precoder matrix for transmissions to the UE device 118 is based on the first cluster wide-beam precoder and the UE-specific precoder information measured by the UE device 118 (W=W₁W₂=R₁r₄). The MU-MIMO precoders for transmissions to the UE devices in the other UE clusters are applied similarly resulting in a first subset of beams 152 directed to the first UE cluster 130, a second subset of beams 154 directed to the second UE cluster 132, and a third subset of beams 156 directed to the third UE cluster 140.

In order to have distinct wide-band precoders the UE clusters 130, 132, 140 are greater than a critical distance, D_{MIN}, away from each. Accordingly, the distance (D1) 158 between the first UE cluster 130 and the second UE cluster 132 is greater than the critical distance, D_{MIN} and the distance (D2) 160 between the first UE cluster 130 and the second UE cluster 132 is greater than the critical distance, D_{MIN}, for the example.

The type of UE-specific precoder and the techniques used to determine the UE-specific precoder information may vary based on the operating frequency since the MIMO channel characteristics vary based on frequency. For example, the MIMO channel characteristics are different in lower frequency bands (e.g., ~1 to 6 GHz) vs. higher bands (e.g., 24-30 GHz) vs. very high bands (e.g., ~70 GHz), etc. Different MIMO processing and/or precoder techniques may be applied to each frequency band.

For example, the propagation loss in the higher frequency bands is relatively high and the channel experiences much less scattering. In this case, a suitable UE-specific precoder includes a precoder where one or more narrow antenna beams are identified by the UE device and reported to the base station as the UE-specific precoder information.

In the lower frequency bands, however, the propagation loss is not as poor, and the channel experiences much more scattering. In this case, a suitable UE-specific precoder includes a precoder based on amplitude and phase adjusted eigen beams that are linearly combined. In one example, the UE device identifies one or more eigen beams from a subset of eigen beams identified by the base station and provides UE-specific precoder information that at least identifies the eigen beams. An example of a suitable method for identifying the beams includes providing a Precoder Matrix Indicator (PMI). The UE-specific precoder information may also include a rank indicating the number of independent beams (orthogonal beams) and a channel quality indicator (CQI). For example, a codebook may include all possible beam combinations for the multiple antennas at the base station. The UE device reports the indicator from the codebook associated with the best combination. The base station provides the UE device with a subset of beams to evaluate so the UE device can efficiently determine the best combination(s). The base station establishes the UE-specific precoder based on the rank and CQI feedback to linearly combine those beams.

The techniques described above facilitate efficient precoder management. After receiving the measured wide-beam precoder from the selected reporting UE device 102 in a UE cluster 130, the base station (gNB) 106 assigns all the UE devices 102, 116-118 determined to be within the maximum distance the same wide-beam precoder W₁ of R₁. Consequently, the base station 106 does not need to gather CSI reports from the remaining UE devices 116-118 in the UE cluster 130. When the base station schedules the next MU-MIMO transmission towards one of the UE devices in the first UE cluster, instead of requesting the whole large-dimensioned matrix, W, the base station 106 only requires the short-term/frequency selective dimension-reduced precoder matrix (UE-specific precoder), W₂, from the particular UE device. The UE device may send the UE-specific precoder information explicitly as a measurement or implicitly as an index of a set of precomputed matrices table/codebook representing the UE-specific precoder, W₂. When multiple UE devices report their measured UE-specific precoder, W₂, the overall feedback overhead and latency are greatly reduced compared to conventional techniques where the entire precoder, W, is reported by each UE device.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17). The UE devices 102, 116-118, 134, 136, 138, 142, 144, 146 may be any type of device that can receive signals from, and transmit signals to, base stations and other UE devices. The UE devices operate in the communication system that includes a plurality of base stations that each provide wireless service within a service area. For the examples of FIG. 1A and FIG. 1B, the UE devices may be served by any one of the base stations and may transition between base stations in accordance with known handover techniques.

For the examples above, the MU-MIMO precoder is the product of two precoders. In some situations, however, the MU-MIMO precoder may be based on more than two precoders. In such situations, a hierarchical precoder structure is implemented where each precoder provides an increased level of granularity to the previous precoder. For example, the MU-MIMO precoder may be the combination of a wide-beam precoder, an intermediate precoder, and a UE specific precoder where the wide-beam precoder provides the most general precoder parameters of the MU-MIMO precoder. The same wide-beam precoder, therefore, can be applied to several UE devices within a maximum distance. The intermediate precoder handles short-term and frequency-selective channel parameters of the MU-MIMO precoder and the UE-specific precoder provides the further short-term and frequency-selective channel parameters of the MU-MIMO precoder. In some situations, the intermediate precoder may apply to more than one UE device. Such a situation may be physically observed in an implementation where the MU-MIMO precoder facilitates antenna beams. For example, the wide-beam precoder may provide the widest antenna beam that applies to a first set of UE devices, the intermediate precoder provides intermediate-wide antenna beams narrower than and within the wide-beam antenna beam, and the UE-specific precoder provides the narrowest beams that are within the intermediate-wide antenna beam. As a result, an intermediate-wide antenna beam may apply to a narrower set of UE devices within the first set where the UE devices in the narrower set are closer to each other than the UE devices in the first set. Therefore, intermediate precoder information, may be provided by a reporting UE device where the base station identifies a set of neighbor UE devices within a maximum distance of the reporting UE device that should be associated with the intermediate precoder. The reporting UE device for the intermediate precoder information may be the same device as the reporting UE device reporting the wide-beam precoder information or may be a different UE device. The reporting UE device reporting the intermediate precoder information, for example, may be a neighbor UE device of another reporting UE device reporting the wide-beam precoder information.

FIG. 1C is a block diagram of an example of an antenna beam configuration for a MU-MIMO precoder 160 that is equal to the product of a wide-beam precoder (W₁), an intermediate-wide precoder (W3), and a UE-specific precoder (W₂). For the example, a wide-beam antenna beam 162 results from a wide-beam precoder (R1), a first intermediate-wide antenna beam 164 results from a first intermediate-wide precoder (I1) and a second intermediate-wide antenna beam 164 results from a second intermediate-wide precoder (I2). Narrow (UE-specific) antenna beams 171-176 result from UE-specific precoders (N1, N2, N3, N4, N5, N6). The narrow antenna beam 172 results from the MU-MIMO precoder (W) equal to the product of R1, I1 and N2 (W=R1*I1*N2). In other implementations, the UE simply selects a narrowest beam out of the above and reports it to the base station. Other precoder combination techniques may be used in some situations.

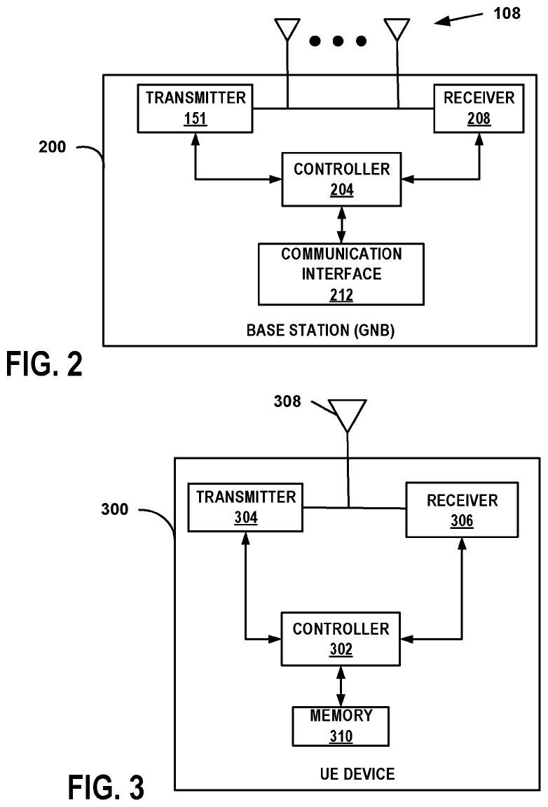

FIG. 2 is a block diagram of an example of a base station 200 suitable for use as the base station 106. The base station 200 includes a controller 204, transmitter 151, and receiver 208, and multiple antennas 108, as well as other electronics, hardware, and code. The base station 200 is any fixed, mobile, or portable equipment that performs the functions described herein. The various functions and operations of the blocks described with reference to the base stations 106, 200 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 151 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 may receive signals through multiple antennas or through a selected antenna of the plurality of antennas 108. The antennas 108 may include separate transmit and receive antennas.

The transmitter 151 and receiver 208 in the example of FIG. 2 perform radio frequency (RF) processing including modulation and demodulation. The receiver 208, therefore, may include components such as low noise amplifiers (LNAs) and filters. The transmitter 151 may include filters and amplifiers. Other components may include isolators, matching circuits, and other RF components. These components in combination or cooperation with other components perform the base station functions. The required components may depend on the particular functionality required by the base station.

The transmitter 151 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders. The controller 204 in conjunction with the transmitter 151 apply the precoder matrix 150 to signals transmitted through the multiple antennas 108.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 102, 115-118, 134, 136, 138, 142, 144, 146, 501-504, 520-525, 542, 604, 606, 608, 610, 660. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

The UE device 300 is capable of transmitting and receiving sidelink signals to and from other UE devices as well as communicating with a base station. The controller 302, in conjunction with the receiver 306, measures signals, such as discovery signals, transmitted by nearby UE devices to generate the neighbor list that includes neighbor UE devices within the maximum distance. The neighbor list is stored in the memory 310 and transmitted to the base station 106 when the UE device 300 is a reporting UE device. The receiver 306 and controller 302 also measure signals transmitted by the base station to determine the wide-beam precoder and the UE-specific precoder information.

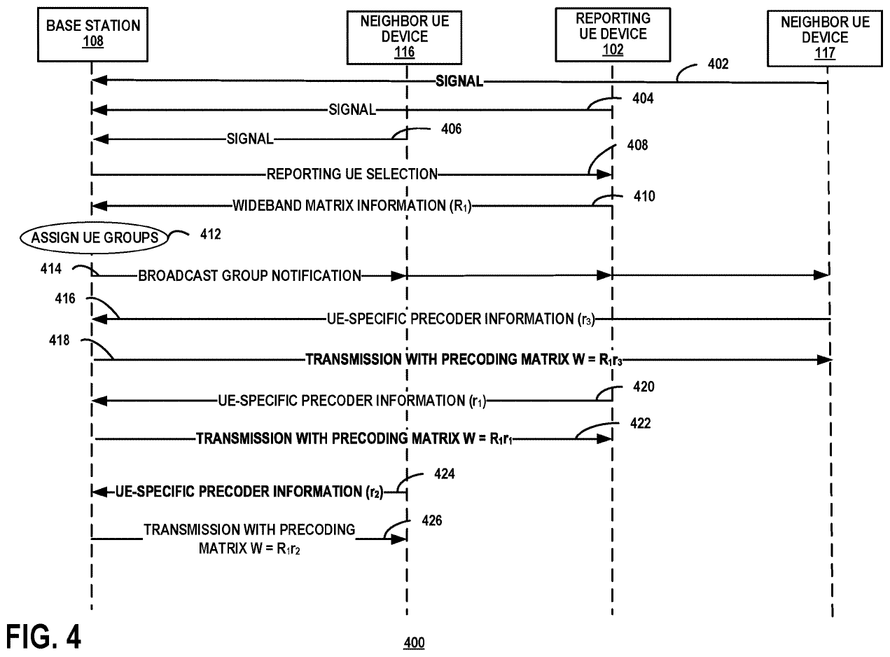

FIG. 4 is a message flow diagram 400 for an example where a precoder is applied to transmissions to three UE devices 102, 116, 117 in a UE cluster 130 where the precoder is the combination of a wide-beam precoder for the UE cluster provided by a reporting UE device 102 of the UE cluster and a UE-specific precoder measured by each UE device.

At transmission 402, a signal is transmitted from the neighbor UE device 117 and received at the base station 106. At transmission 404, a signal is transmitted from the reporting UE device and received at the base station 106, At transmission 406, a signal is transmitted from the neighbor UE device 116 and received at the base station 106. As mentioned before the signals either include geo-location information or assist the based station in tracking the location of the UE device.

At transmission 408, the base station 106 sends a reporting UE selection message to instruct the reporting UE device 102 to report the measured wideband precoding matrix, R₁. The reporting UE selection message may include additional information such as schedule for reporting the wide-beam precoder information.

At transmission 410, the reporting UE device reports the wide-beam precoder information to the base station 106. The precoder information may be a measured matrix (R1).

At event 412, the reporting UE device 102 evaluates the locations of the UE devices 102, 116, 117 and assigns both UE devices 116, 117 to the same group of the reporting UE device. For the example of FIG. 4, therefore, the UE devices 116, 117 are within the maximum distance of the reporting UE device 102.

At transmission 414, the base station broadcasts the group notification. As discussed above, the group notification may be sent using any one of several techniques. The group notification indicates grouping of the UE devices as well as the providing a wide-beam precoder identifier indicating the wide-beam precoder that is assigned to each group.

At transmission 416, the neighbor UE device 117 transmits UE-specific precoder information to the base station 106. The neighbor UE device 117 measures signals transmitted by the base station to determine the channel conditions and to determine the UE-specific precoder, r₃. In some circumstances the transmission 416 is in response to a request from the base station 106. For example, the base station 106 may request UE-specific precoder information from the neighbor UE device 117 where the request provides information that can be used by the UE device 117 to measure the channel conditions. An example of a suitable request includes the base station utilizing the CSI-reportConfig to set the parameters for what the UE device should provide. For the example, the UE device reports RI, CQI and the PMI in response to the request. The CSI-reportConfig includes the multi-antenna configurations of the base station, CSI resources, sub-bands to be reported, and the codebook details, as well as other information. The base station can configure the UE device to report back periodically and aperiodically. The UE device reports the measurements based on those settings in the CSI-measurementReport. In another example, the transmission 416 is in response to the UE device determining that the UE device has been associated with the appropriate wide-beam precoder by the base station. In such situations, the UE device 117 may receive the measurement configuration in the SIB.

At transmission 418, the base station 106 transmits a signal to the neighbor UE device 117 through the multiple antennas 108 by applying a precoder matrix, W, that is equal to the combination of the wideband precoding matrix (R₁) for the first UE cluster and the UE-specific precoder (r₃) measured by the neighbor UE device 117. For the example, the combination of the precoders is the product of the precoder matrices.

At transmission 420, the reporting UE device 102 transmits UE-specific precoder information to the base station 106. The reporting UE device 102 measures signals transmitted by the base station 106 to determine the channel conditions and to determine the UE-specific precoder, r₁. In some situations, the reporting UE device may report the wide-beam precoder information and the UE-specific precoder information in the same transmission. Accordingly, transmission 410 and transmission 420 may be combined and transmitted at transmission 410 in some situations. In such situations the transmission 410 is constructed in such a way that the base station is able to interpret the transmission to determine the wide-beam precoder information.

At transmission 422, the base station 106 transmits a signal to the reporting UE device 102 through the multiple antennas 108 by applying a precoder matrix, W, that is equal to the product of the wideband precoding matrix (R₁) for the first UE cluster and the UE-specific precoder (r₁) measured by the reporting UE device 102.

At transmission 424, the neighbor UE device 116 transmits UE-specific precoder information to the base station 106. The neighbor UE device 117 measures signals transmitted by the base station to determine the channel conditions and to determine the UE-specific precoder, r₂.

At transmission 426, the base station 106 transmits a signal to the neighbor UE device 116 through the multiple antennas 108 by applying a precoder matrix, W, that is equal to the product of the wideband precoding matrix (R₁) for the first UE cluster and the UE-specific precoder (r₂) measured by the neighbor UE device 116.

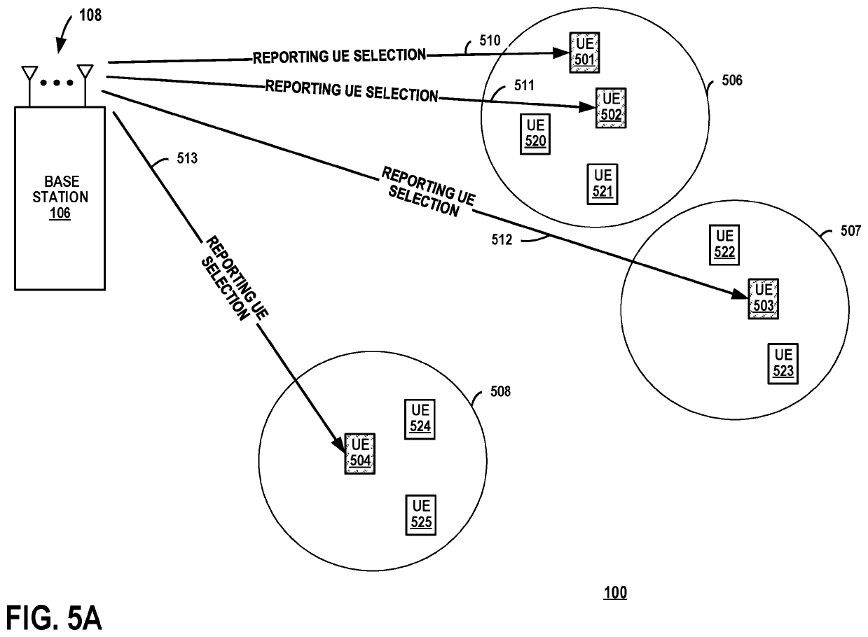

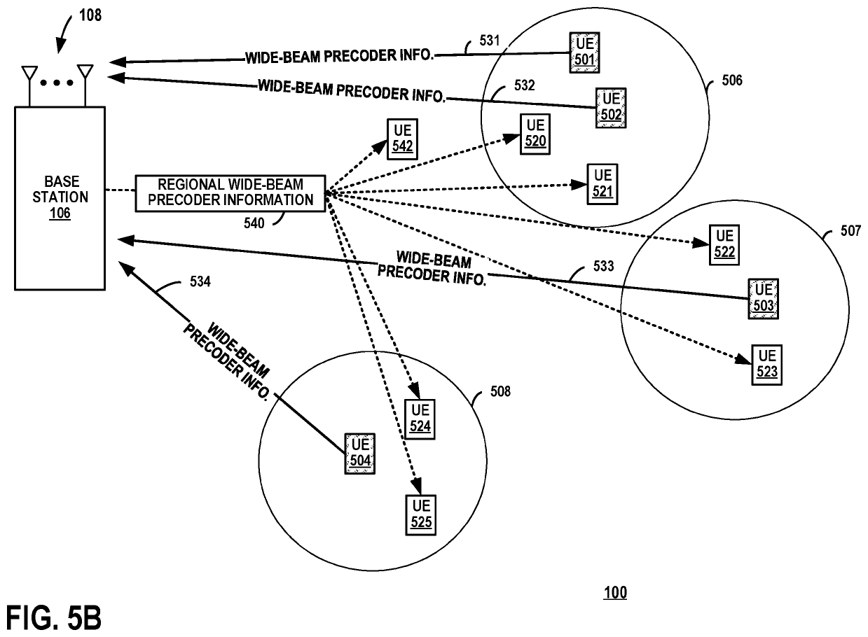

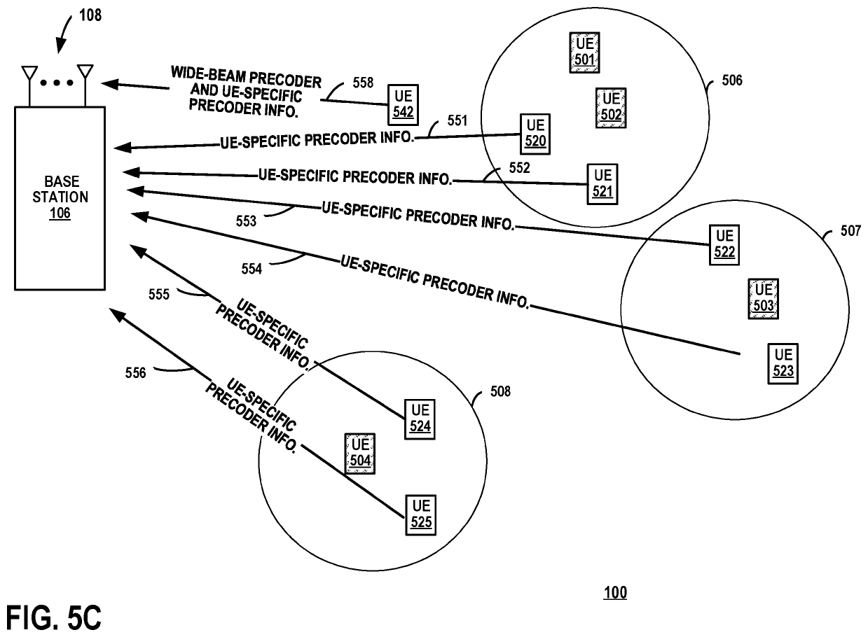

FIG. 5A is a block diagram of the system 100 for an example where the base station 106 selects reporting UE devices 501-504 from geographical regions 506-508 to report wide-beam precoder information. The based station 106 tracks the geo-locations of some UE devices 501-504 and selects at least one UE device from each region to be a reporting UE device. For the example, the base station 106 sends a reporting UE selection message 510-513 to each UE device that is selected to be a reporting UE device. As discussed above, an example of suitable technique for sending the reporting UE selection message includes the base station 106 sending an RRC Reconfiguration message to each selected reporting UE device instructing the UE device to measure the downlink reference signal (DL RS) and report the results. For the example of FIG. 5A, the base station 106 selects two reporting UE devices 501, 502 from a first region 506, a reporting UE device 503 from a second region 507, and a reporting UE device 504 from a third region 508. The other UE devices 520-525 in the regions 506-508 are not selected either because their locations are not being tracked or for other reasons. Although there may be several ways to select a reporting UE device, an example of a suitable technique includes selecting a UE device in the RRC connected state that has a downlink Signal to Interference and Noise Ratio (DL SINR) that is above a threshold. Each region is associated with a wide-beam precoder where the wide-beam precoder is used by the MU-MIMO precoder for transmissions to all UE devices in the region. In some situations, the regions 506-508 are preconfigured by the base station at deployment. In other situations, the regions may be modified based on conditions or information. Artificial Intelligence (AI) learning techniques, for example, may be applied to determine the most efficient and reliable regions shape and sizes.

FIG. 5B is a block diagram of the system for an example where each reporting UE device 501-504 reports wide-beam precoder information 531-534 and the base station broadcasts regional wide-beam precoder information 540. Therefore, the UE devices that received a reporting UE selection message as discussed with reference to FIG. 5A, report wide-beam precoder information. The reported wide-beam precoder information may be a precoder indicator (PMI), a Synchronization Signal Block (SSB) indicator indicating an SSB, channel estimate information, or an index in a codebook.

For the example, the first reporting UE device 501 in the first region 506 measures downlink signals and reports the wide-beam precoder information 531 and the second reporting UE device 502 in the first region 506 measures downlink signals and reports the wide-beam precoder information 532. The third reporting UE device 503 in the second region 507 measures downlink signals and reports the wide-beam precoder information 533. The fourth reporting UE device 504 in the third region 508 measures downlink signals and reports the wide-beam precoder information 534. Based on the reported wide-beam precoder information 531-534, the base station 106 determines the appropriate wide-beam precoder that should be used in the MU-MIMO precoder for transmissions to each region 506-508. The base station 106 broadcasts regional wide-beam precoder information 540 that identifies the wide-beam precoders assigned to each region 506-508. The regional wide-beam precoder information 540 is transmitted in the direction of the regions 506-508 such that UE devices 501-504, 520-525, 542 located within the regions or near the regions are able to receive the broadcast. The wide-beam precoders represented in the regional wide-beam precoder information 540 is subset of the set of all the wide-beam precoders used by the base station 106 in the MU-MIMO precoder. In some situations, the regional wide-beam precoder information is broadcasted in a System Information Block (SIB). In other situations, the regional wide-beam precoder information may be periodically-transmitted in a MIMO Control Channel (MiCCH).

FIG. 5C is a block diagram of the system 100 for an example where UE devices report UE-specific precoder information when the UE device determines that a preferred wide-beam precoder measured by the UE device matches one of the wide-beam precoders identified by the regional wide-beam precoder information 540. Accordingly, each UE device compares the regional wide-beam precoder information 540 discussed with reference to FIG. 5B to wide-beam precoder data determined by measuring downlink signals (not shown) transmitted from the base station 106. For the example of FIG. 5C, the reporting UE devices 501-504 have already provided UE-specific precoder information and are not shown transmitting UE-specific precoder information. The reporting UE devices 501-504, for example, may have reported their UE-specific precoder information with the reported wide-beam precoder information.

The UE-specific precoder information may include measured Channel State Information (CSI) in some situations. The base station may transmit a narrow beam measurement configuration the UE device and the UE device determines narrow beam information by applying the narrow beam measurement configuration to measure CSI. The UE reports the CSI and the base station applies a UE-specific precoder based on the CSI for transmissions to the UE device. Other examples of suitable techniques for reporting the UE-specific precoder information include transmitting a frequency selective sub-band indicator, a short-term channel indicator, channel estimate information, a beam indicator indicating at least one antenna beam, or an index in a codebook.

In some examples, the UE devices also provide a wide-beam precoder index that identifies the wide-beam precoder that is matched to the preferred wide-beam precoder. The UE devices 520, 521 in the first region, therefore, provide a wide-beam precoder index identifying the wide-beam precoder assigned to the first region 506 in addition to providing each of their UE-specific precoder information 551, 552. Similarly, the UE devices 522, 523 in the second region 507 report the precoder index identifying the wide-beam precoder assigned to the second region 507 in addition to providing each of their UE-specific precoder information 553, 554. The UE devices 524, 525 in the third region 508 report the precoder index identifying the wide-beam precoder assigned to the third region 508 in addition to providing each of their UE-specific precoder information 555, 556. In some situations, a UE device is not required to send the wide-beam precoder index if the UE device has already provided the wide-beam precoder index and the preferred wide-beam precoder has not changed. Accordingly, a UE device reports the wide-beam precoder index the first time the UE device reports the UE-specific precoder information and only reports the wide-beam precoder index if the UE device moves to another region. Where the UE device is stationary, the UE device may only need to send the wide-beam precoder index once to the base station when the UE device enters the RRC CONNECTED state.

In other examples, the UE devices are not required to report the wide-beam precoder index. Where hierarchical precoders are used, for example, the UE-specific precoders are unique. Since a hierarchical codebook has a layered structure and the UE-specific precoder uniquely belongs to a sub-group of the wide-beam precoder. As a result, the UE-specific precoder information inherently identifies the wide-beam precoder. Other examples include any situation where the UE-specific precoders are unique.

A UE device 542 that cannot match the measured preferred wide-beam precoder to one of the plurality of precoders identified by the regional wide-beam precoder information, transmits preferred wide-beam precoder information identifying the measured preferred wide-beam precoder as well as transmitting the UE-specific information. For the example of FIG. 1C, therefore, the UE device 542 transmits measured wide-beam precoder information and UE-specific precoder information 558.

The base station 106 applies the MU-MIMO precoder for transmissions through the plurality of antennas 108 to the UE devices 520-525 where the MU-MIMO precoder for each UE device is equal to the combination of the UE-specific precoder identified by each UE device and the wide-beam precoder assigned to the geographical region where the UE device is located. For transmissions to the UE device 510 in the first region 506, for example, the base station applies a MU-MIMO precoder equal to the combination of the wide-beam precoder assigned to the first region 506 and the UE-specific precoder identified by the UE-specific precoder information received from the UE device 520.

The techniques discussed above may be applied to hierarchical precoders in some situations. The MU-MIMO precoder, for example, may be formed by a combination of the wide-beam precoder, an intermediate-beam precoder, the UE-specific precoder.

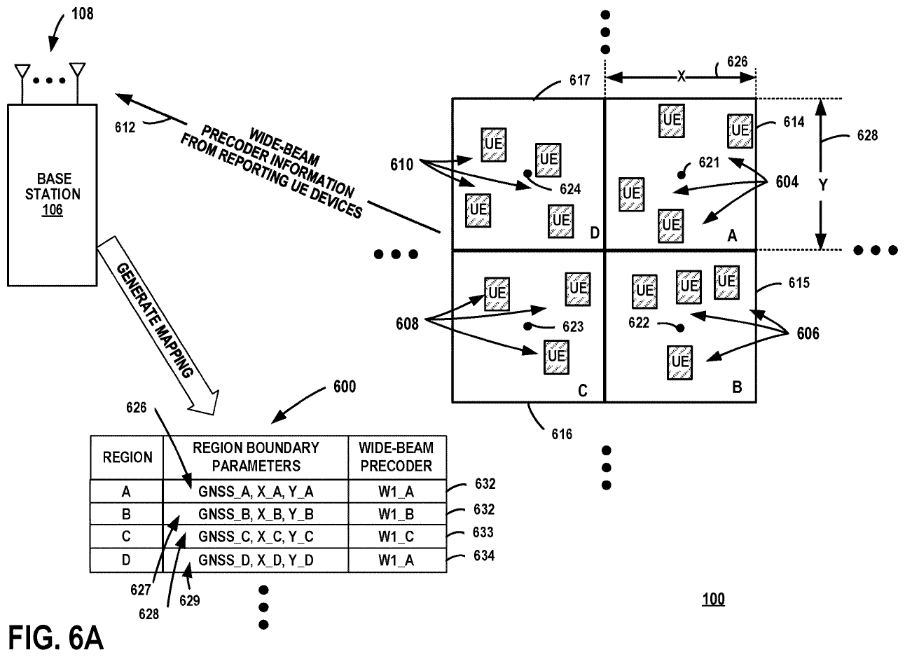

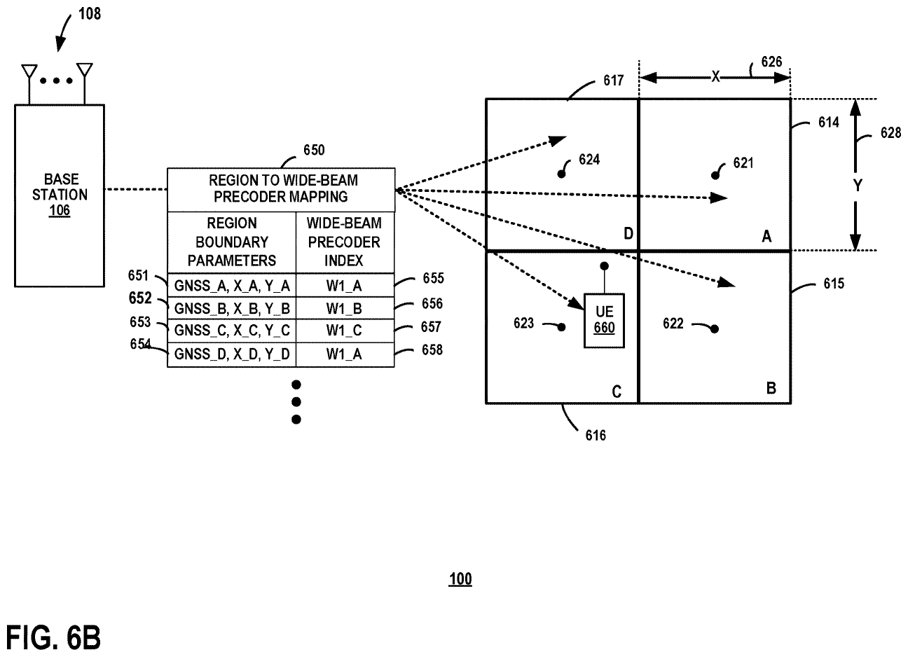

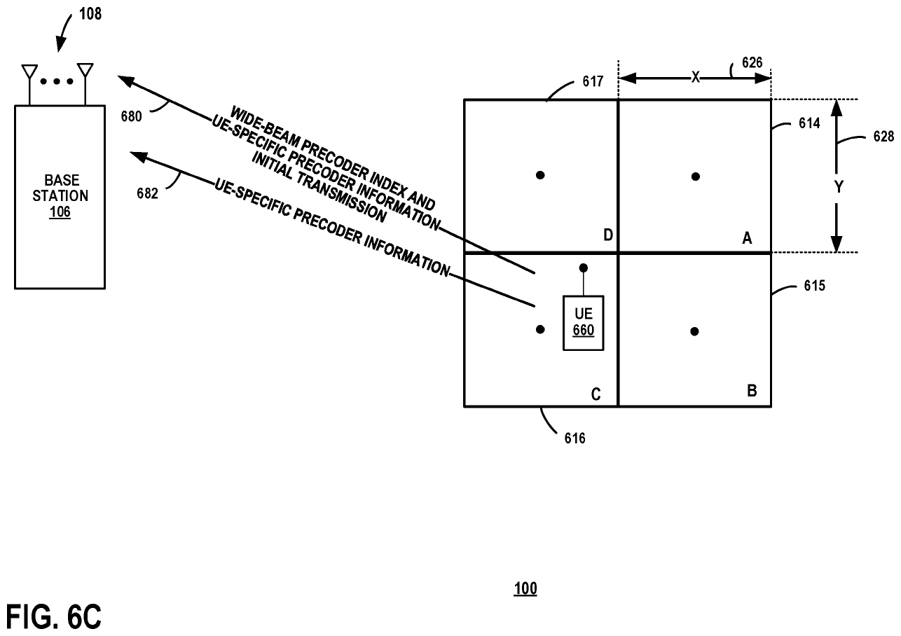

FIG. 6A, FIG. 6B and FIG. 6C are block diagrams of the system 100 for an example where the base station 106 transmits regional wide-beam precoder information that includes a geographical region to wide-beam precoder mapping. For the example, the base station 106 performs a wide-beam precoder data acquisition and mapping procedure where reporting UE devices provide regional wide-beam precoder information during the data acquisition period and the base station compiles and evaluates, or otherwise processes, the data to define region boundaries and to generate a mapping between the regions and wide-beam precoders. A UE device may use the region to precoder mapping to limit the wide-beam precoder information that it provides to the base station. In some situations, the UE device in RRC_CONNECTED determines its current region, verifies that the UE device's measured preferred wide-beam precoder matches the assigned wide-beam precoder for the current region, and reports the wide-beam precoder information only in an initial report. Although the UE device initially reports the wide-beam precoder information with UE specific precoder information, the UE device only reports UE-specific precoder information in subsequent reports unless the UE device moves to a new region. The UE device may detect that it has moved to new region based on its location and/or based on measuring a new preferred wide-beam precoder. In another situation, a UE device in the RRC IDLE state initiates a PRACH procedure based on its current region. After determining the current region in which the UE device is located, the UE device determines the wide-beam precoder assigned to the region and uses a PRACH associated with the assigned wide-beam precoder. With such a procedure, delays due to measuring periodically transmitted precoder references signals are avoided since the UE device does not wait for sweeping transmissions of precoder reference signals. The UE device in RRC IDLE may transmit the preamble associated with the assigned wide-beam precoder based on its current region, before the precoder reference signals is received at the UE device.

FIG. 6A is a block diagram of the system 100 for an example where the base station 106 receives generates a region to wide-beam precoder mapping 600 based on wide-beam precoder information 602 received from a plurality of reporting UE devices 604, 606, 608, 610. For the example, the base station 106 performs a data acquisition and mapping procedure after the deployment of the base station 106 in the system 100. The data acquisition and mapping procedure, however, can be performed at other times to improve performance. The procedure may be performed after changes in the area around the base station that result in changes in wireless channel characteristics and signal propagation, for example. The data acquisition and mapping procedure is performed over a period of time that is sufficient to generate a region to wide-beam precoder mapping with the appropriate accuracy. An example of a sufficient period of time includes a week although the procedure may be performed over different periods, such as multiple days or multiple weeks. The time period may depend on several factors, such as the number of reporting UE devices, the desired accuracy of the mapping, and the terrain of the area.

The base station 106 selects UE devices to be reporting UE devices and instructs the reporting UE devices 604, 606, 608, 610 to measure and report wide-beam precoder information 612. The base station 106 tracks the locations of the reporting UE devices 604, 606, 608, 610 using known techniques. In some situations, a reporting UE device may provide its location when reporting the wide-beam precoder information. Each reporting UE device measures downlink signals transmitted by the base station 106 to determine a preferred wide-beam precoder for its current location and reports wide-beam precoder information that identifies the preferred wide-beam precoder. The wide-beam precoder information may include measurements in some situations. In other situations, the wide-beam precoder information may be a wide-beam precoder index that identifies the preferred wide-beam precoder from a set of predetermined wide-beam precoders. In one example, the reporting UE devices report a preferred SSB.

The base station 106 acquires the wide-beam precoder information 612 that includes the wide-beam precoder information provided by each reporting UE device and generates the region to wide-beam precoder mapping 600 based on the received information and the locations of the reporting UE devices 604, 606, 608, 610. For the example, the base station 106 determines the appropriate boundaries of a plurality of regions 614-617 as part of the mapping generation. The regions 614-617 may be defined to have any shape and size. Although the, regions may have the same shape and size, in most situations, the regions have the same shape but different sizes. The regions may be defined using any of several techniques and parameters. For the example of FIG. 6A, the regions are rectangular and each region is defined with a geographical coordinate 621-624 and lengths 626, 628 of the rectangularly shaped region. FIG. 6A shows the X length 626 and the Y length 628 for region A 614. The lengths of the other regions are omitted in FIG. 6A in the interest of clarity and brevity. Each region 614-617 is defined by a GNSS coordinate 621-624 and a X-length and Y length such that each side of the rectangle is half the distance of the adjacent length from the GNSS coordinate. The orientation of the rectangles may be based on a predetermined direction such an angle from a cardinal direction. For example, the Y lengths may be parallel to north-south. Other boundary parameters can be used in some situations. In one example, the set of boundary parameters includes a GNSS coordinate and a radius to define a circular region. In another example, the set of boundary parameters includes a series of GNSS coordinates that define a perimeter of the region. In such an example, the GNSS coordinates may be provides in an order where lines extending from consecutive coordinates form an edge of the region. Such a region description allows for a large number of potential regular and irregular region shapes.

The region to wide-beam precoder mapping 600 includes at least a set of region boundary parameters 626-629 associated with a wide-beam precoder 631-634 where each set of region boundary parameters defines a region. Accordingly, for the example, a set of region boundary parameters 626 defining region A 614 is associated with a first wide-beam precoder (W1_A) 631, a set of region boundary parameters 627 defining region B 615 is associated with a second wide-beam precoder (W1_B) 632, and set of region boundary parameters 628 defining region C 616 is associated with a third wide-beam precoder (W1_C) 633. In some situations, two or more regions may be assigned the same wide-beam precoder. For the example of FIG. 6, the set of parameters 629 defining region D 617 is associated with a fourth wide-beam precoder (W1_A) 634 that is the same as the wide-beam precoder (W1-A) 631 for region A 614.

The region to wide-beam precoder mapping 600 may include additional parameters to the region boundary parameters and wide-beam precoders. For the example, the region to wide-beam precoder mapping 600 is based on the day of the week and time of day. Accordingly, the mapping 600 may include different regions and precoders based on the day and time of day. One such scenario may occur where the wide-beam precoder information 612 reveals that, due to variations in vehicular traffic during the week or time of day, there are changes data traffic and interference which results in a different mapping. In other situations, the number of UE devices may vary over time resulting in different mappings even though the structural surroundings may be relatively fixed causing minimal changes to the channel environment.

The region to wide-beam precoder mapping 600 may include any number of regions and wide-beam precoders. Although FIG. 6A shows four regions 614-617, additional regions may be defined in one or more directions from the four regions. A region to wide-beam precoder mapping 600 is generated for each cell that the base station 106 provides. Accordingly, another region to wide-beam precoder mapping may be generated in a different direction form the base station of a geographical area being served by a cell different from the cell with the region to wide-beam precoder mapping 600.

The data acquisition and mapping procedure may be performed using different techniques. In one example, the base station 106 complies and stores the data and correlates the locations of the reporting UEs to the wide-beam precoders. In another example, the data received from the reporting UE devices may be processed by a machine learning (ML) or AI processor where the base station uses the past precoder information reports to train the AI/ML model which maps the regions to the wide-beam precoders.

The wide-beam precoder information 612 includes wide-beam precoder information reported by a plurality of reporting UE devices from each area that is eventually defined as a region by the base station 106. Accordingly, the wide-beam precoder information 612 includes wide-beam precoder information from a first plurality of reporting UE devices 604 in region A 614, wide-beam precoder information from a second plurality of reporting UE devices 606 in region B 615, wide-beam precoder information from a third plurality of reporting UE devices 608 in region C 616, and wide-beam precoder information from a fourth plurality of reporting UE devices 610 in region D 617. The wide-beam precoder information 612 is compiled over time, it is possible for a reporting UE device from one region to also be a reporting UE device for other regions.

FIG. 6B is a block diagram of the system 100 for an example where the base station transmits a region to wide-beam precoder mapping message 650. For the example, the region to wide-beam precoder mapping message 650 is broadcasted in a SIB and can be received by UE devices within the regions included in the mapping. The mapping message 650 may be transmitted using other techniques, such as broadcasting the mapping message using a control channel. The region to wide-beam precoder mapping message 650 includes sets of region boundary parameters 651-654 where each set is associated with a wide-beam precoder identifier 655-658. For the example, the wide-beam precoder identifiers 655-658 are indices in a codebook that is preconfigured and established by the network of the system 100. Accordingly, all UE devices are aware of the codebook, can decipher the wide-beam precoder index 655-658 and associate each index with a wide-beam precoder.

For the example of FIG. 6B, a UE device 660 within region C 616 receives the broadcasted mapping message 650. The UE device 660 determines its current location and, based on the current location and the region boundary parameters 653, determines that the UE device 660 is located with region C 616. The UE device measures downlink signals transmitted from the base station 106 to measure a preferred wide-beam precoder. The UE device compares the measured preferred wide-beam precoder to the wide-beam precoder associated with region C in the mapping message 650 to determine if the measured wide-beam precoder is the same as the assigned wide-beam precoder. In particular, since the UE device knows it is in region C, it can quickly measure the wide-beam precoder for this region without measuring all the possible wide-beam precoders transmitted by the base station 106.

FIG. 6C is a block diagram of the system for an example where the UE device 660 transmits a wide-beam precoder index and UE-specific precoder information in an initial transmission and transmits UE specific precoder information without wide-beam precoder information in subsequent reports. After determining that the measured preferred wide-beam precoder is the same as the side-beam precoder associated with the region as discussed above, the UE device 660 transmits a wide-beam precoder index and UE-specific precoder information in an initial transmission 680 to the base station 106. The wide-beam precoder index identifies the wide-beam precoder associated with current region of the UE device 660. For the example, therefore, the wide-beam precoder index in the initial transmission 680 is the wide-beam precoder index (W1_C) 657. The UE device only reports UE-specific precoder information 682 without transmitting wide-beam precoder information in subsequent transmissions. If conditions change, such as when the UE device moves into another region, the UE device transmits a new wide-beam precoder index and UE-specific precoder information in an initial transmission from the new region. Accordingly, the reporting of precoder information by UE devices is more efficient since transmissions of the wide-beam precoder information are minimized, or at least reduced, compared to conventional techniques. In addition, latency is reduced since UE devices are not required to complete the measurement procedures and reporting related to wide-beam precoder information. The base station only tracks locations of UE devices during the data acquisition and mapping generation procedure and does not need to track the UE devices during operation.

The base station applies the MIMO precoder for transmission to the UE device 660 that is combination of wide-beam precoder for the region and the UE-specific precoder identified by the UE-specific precoder information reported by the UE device 660.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A neighbor user equipment (UE) device comprising:
a receiver configured to receive, from a base station, a group notification indicating the neighbor UE device belongs to a UE group and identifying a wide-beam precoder; and
a transmitter configured to transmit, to the base station, UE-specific precoder information without transmitting wide-beam precoder information,
the receiver configured to receive a transmission transmitted by the base station through a plurality of antennas using a Multiple User Multiple Input Multiple Output (MU-MIMO) precoder equal to a combination of the UE-specific precoder and a wide-beam precoder, the wide-beam precoder determined by the base station based at least partially on wide-beam precoder information provided by a reporting UE device different from the neighbor UE device.

2. The neighbor UE device of claim 1, wherein the UE-specific precoder information is one of a frequency selective sub-band indicator, short-term channel indicator, channel estimate information, a beam indicator indicating at least one antenna beam, or an index in a codebook.

3. The neighbor UE device of claim 1, wherein the MU-MIMO precoder is formed by a combination of the wide-beam precoder, an intermediate-beam precoder, the UE-specific beam precoder.

4. The neighbor UE device of claim 1, wherein the wide-beam precoder information is one of a precoder indicator (PMI), a Synchronization Signal Block (SSB) indicator indicating an SSB, channel estimate information, or an index in a codebook.

5. The neighbor UE device of claim 1, wherein the reporting UE device is within a maximum distance of the neighbor UE device.

6. The neighbor UE device of claim 1, wherein the receiver is configured to receive the request for UE-specific precoder information by receiving a narrow beam measurement configuration from the base station,
the neighbor UE device further comprising a controller configured to determine narrow beam information by applying the narrow beam measurement configuration to measure Channel State Information (CSI), the transmitter further configured to transmit the CSI to the base station, the UE specific precoder based on the CSI.

7. The neighbor UE device of claim 1, wherein the wide-beam information identifies a subset of antenna beams of a plurality of antenna beams from the base station and the UE-specific precoder adjusts a phase and amplitude of each antenna beam of the subset of antenna beams and linearly combines the subset of antenna beams.

8. The neighbor UE device of claim 1, wherein a wideband precoding matrix is used by the base station for a MU-MIMO precoding matrix for transmissions to the reporting UE device.

9. The neighbor UE device of claim 1, wherein the transmitter is configured to transmit the UE-specific precoder information without transmitting wide-beam precoder information in response to the group notification.

10. The neighbor UE device of claim 1, further comprising a controller configured to determine based, at least partially, on measurement signals received from the base station, a preferred wide-beam precoder and to determine if the wide-beam precoder identified by the group identifier is the same as the preferred wide-beam precoder,
the transmitter configured to transmit the UE-specific precoder information without wide-beam precoder information when the wide-beam precoder identified by the group identifier is the same as the preferred wide-beam precoder.

11. The neighbor UE device of claim 10, the transmitter configured to transmit the preferred wide-beam precoder information indicating the preferred wide-beam precoder when the wide-beam precoder identified by the group identifier is not the same as the preferred wide-beam precoder.

12. The neighbor UE device of claim 10, wherein the receiver is configured to receive a broadcasted System Information Block (SIB) comprising a UE identifier for each UE device in the UE group and a group mapping indication indicating a correlation between each UE group of a plurality of UE groups and a corresponding wide-beam precoder of a plurality of wide-beam precoders.

13. The neighbor UE device of claim 10, wherein the group identifier is a MIMO-Radio Network Temporary Identifier (MiRNTI), the receiver configured to receive a periodically-transmitted MIMO Control Channel (MiCCH) comprising a plurality of MiRNTIs and a plurality of UE device identifiers associated with each MiRNTI.

14. The neighbor UE device of claim 13, wherein the plurality of UE device identifiers identifies UE devices that have changed groups since a previous MiCCH broadcast.

15. A base station comprising:
a controller configured to:
determine a geographical location of each user equipment (UE) device of a plurality of UE devices,
identify, from the plurality of UE devices, a reporting UE device, and
identify, from the plurality of UE devices, a UE device cluster comprising at least one cluster UE device within a maximum distance from the reporting UE device;
a transmitter configured to instruct the reporting UE device to report wide-beam precoder information indicative of a wide-beam precoder;
a receiver configured to receive the wide-beam precoder information from the reporting UE device; and
a plurality of antennas, the transmitter configured to apply a Multiple User Multiple Input Multiple Output (MU-MIMO) precoder when transmitting through the plurality of antennas, the MU-MIMO precoder equal to a combination of the wide-beam precoder and at least one other precoder, the transmitter configured to apply the wide-beam precoder for transmissions to the reporting UE device and to the at least one cluster UE device of the UE device cluster without the at least one cluster UE device identifying the wide-beam precoder.

16. The base station of claim 15, wherein the receiver is further configured to receive, from the reporting UE device, first UE-specific precoder information indicative of a first UE-specific precoder and to receive, from one of the cluster UE devices, second UE-specific precoder information indicative of a second UE-specific precoder, the transmitter configured to apply the first MU-MIMO precoder to a first transmission to the reporting UE device and to apply a second MU-MIMO precoder to a second transmission to the one of the cluster UE devices, the first MU-MIMO precoder equal to a combination of the wide-beam precoder and the first UE-specific precoder, the second MU-MIMO precoder equal to a combination of the wide-beam precoder and the second UE-specific precoder.

17. The base station of claim 16, wherein the transmitter is further configured to transmit a first request for UE-specific precoder information to the reporting UE device and to transmit a second request for UE-specific precoder information to the one of the cluster UE devices.

18. The base station of claim 17, wherein:
the controller is configured to determine a precoder measurement configuration based on the wide-beam precoder information,
the first request for UE-specific precoder information comprises the precoder measurement configuration identifying measurements to determine the first UE-specific information, and
the second request for UE-specific precoder information comprises the precoder measurement configuration identifying measurements to determine the second UE-specific information.

19. The base station of claim 16, wherein the transmitter is further configured to transmit a group notification indicating the cluster UE devices belong to a UE group.

20. The base station of claim 19, wherein the wherein the group notification identifies the wide-beam precoder.

21. The base station of claim 20, wherein second UE-specific precoder information is transmitted from the one of the cluster UE devices in response to the group notification.

22. The base station of claim 21, wherein the one of the cluster UE devices is configured to periodically transmit the second UE-specific precoder information in response to the group notification.

23. The base station of claim 20, wherein the transmitter is configured to broadcast system information block (SIB) comprising a UE identifier for each UE device in the UE group.

24. The base station of claim 20, wherein the group identifier is a MIMO-Radio Network Temporary Identifier (MiRNTI), the transmitter configured to periodically transmit a MIMO Control Channel (MiCCH) comprising a plurality of MiRNTIs and a plurality of UE device identifiers associated with each MiRNTI.

25. The base station of claim 24, wherein the plurality of UE device identifiers identifies UE devices that have changed groups since a previous MiCCH broadcast.
